(19) United States
(12) Patent Application Publication
(10) Pub. No.: US 2026/0234383 A1
(43) Pub. Date: Aug. 13, 2026

(54) RUBBER COMPOSITION BASED ON A HIGHLY SATURATED DIENE ELASTOMER AND A REINFORCING RESIN

(71) Applicant: COMPAGNIE GENERALE DES ETABLISSEMENTS MICHELIN, Clermont-Ferrand (FR)

(72) Inventors: THOMAS FERRAND, Clermont-Ferrand (FR); GUILLAUME PIBRE, Clermont-Ferrand (FR)

(21) Appl. No.: 19/155,092

(22) PCT Filed: Feb. 6, 2024
(86) PCT No.: PCT/EP2024/052843

§ 371 Date: Aug. 8, 2025

(30) Foreign Application Priority Data
Feb. 9, 2023 (FR) 2301205

(51) Int. Cl. C08L 23/0807; B60C 1/00

(52) U.S. Cl. CPC C08L 23/083; B60C 1/00; C08L 2312/00

(57) ABSTRACT

A rubber composition is based on at least one elastomer matrix comprising more than 50 phr of at least one copolymer containing ethylene units and 1,3-diene units; a reinforcing filler; a vulcanization system; from 1 to 30 phr of epoxy resin and between 1 and 15 phr of an amine-based hardener comprising at least two primary amine functions, located on at least one six-membered aromatic ring comprising at least one primary amine function, and at least two radicals Ri chosen from C₁-C₆ alkyl radicals, halogens, ethers, tertiary amines, thioethers, ketones, esters and amides, substituted with C₁-C₆ alkyl radicals, such that the at least one six-membered aromatic ring does not comprise a hydrogen atom located in the ortho position relative to the primary amine functions, the amine-based hardener comprising at least one second primary amine function.

The present invention relates to rubber compositions intended notably for the manufacture of tyres or of semi-finished products for tyres.

Tyre layers such as the tread or the internal layers must comply with a large number of, often contradictory, technical requirements including low rolling resistance, high wear resistance, good road behavior, and also a good level of cohesion of the material.

In order to ensure good stiffness, which is notably representative of the road behavior, it is known practice to use rubber compositions which have high contents of reinforcing fillers. However, in a known manner, increasing the filler content can penalize the hysteresis properties and thus the rolling resistance of tyres.

High stiffness can also be obtained by incorporating certain reinforcing resins as disclosed in patent application WO 02/10269, which proposes rubber compositions which have high stiffness at low tyre strains. Resistance to small strains is one of the properties which a tyre must have in order to respond to the stresses to which it is subjected.

Furthermore, it remains advantageous that the solutions provided in order to solve this problem not be disadvantageous to the other properties of the rubber composition, in particular the hysteresis. This is because the use of a hysteretic composition in a tyre may be evidenced by a rise in the internal temperature of the tyre, which may result in a reduction in the durability of the tyre. In the light of the foregoing, it is an ongoing objective to provide rubber compositions which have an improved compromise between resistance to stiffness and hysteresis. Needless to say, it remains advantageous that the improvement of this compromise not be achieved at the expense of other properties of the composition, in particular mechanical properties such as the elongation at break and the breaking stress (or tensile strength), which are particularly important properties in many internal layers of tyres.

Thus, there is a need to find ways to improve the durability of tyres comprising high-stiffness compositions without penalizing the hysteresis, or even improving it, and without penalizing the mechanical properties of the composition.

Continuing its research, the Applicant discovered, unexpectedly, that the combined use of highly saturated diene elastomer and a curing system based on epoxy resin and a particular amine-based hardener allows the abovementioned performance compromise to be further improved.

Thus, a subject of the invention is a rubber composition based on at least:
an elastomer matrix comprising more than 50 phr of at least one copolymer containing ethylene units and 1,3-diene units, the ethylene units in the copolymer representing between 50 mol % and 95 mol % of the monomer units of the copolymer,
a reinforcing filler,
a vulcanization system,
from 1 to 30 phr of epoxy resin,
between 1 and 15 phr of an amine-based hardener comprising at least two primary amine functions located on at least one six-membered aromatic ring, said at least one six-membered aromatic ring comprising:
   at least one primary amine function, and
   at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals,
      so that the at least one six-membered aromatic ring does not comprise a hydrogen atom located in the ortho position relative to the primary amine functions,
      said amine-based hardener comprising at least one second primary amine function located on said at least one six-membered aromatic ring or on a possible second six-membered aromatic ring of said amine-based hardener.

A subject of the present invention is also a tyre comprising a composition according to the invention.

### I—DEFINITIONS

The expression “composition based on” should be understood as meaning a composition including the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

The term “elastomer matrix” means all of the elastomers of the composition, including the copolymer defined below.

Unless otherwise indicated, the contents of the units resulting from the insertion of a monomer into a copolymer are expressed as molar percentages relative to all of the monomer units of the copolymer.

For the purposes of the present invention, the expression “part by weight per hundred parts by weight of elastomer” (or phr) should be understood as meaning the part by mass per hundred parts of elastomer present in the rubber composition under consideration.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present text, when an interval of values is denoted by the expression “from a to b”, the interval represented by the expression “between a and b” is also and preferentially denoted.

The compounds mentioned in the description may be of fossil origin or may be biobased. In the latter case, they may be partially or completely derived from biomass or obtained from renewable raw materials derived from biomass. Similarly, the compounds mentioned may also originate from the recycling of already-used materials, i.e. they may partially or totally result from a recycling process, or else be obtained from raw materials which themselves result from a recycling process. Polymers, plasticizers, fillers, and the like, are notably concerned.

Unless otherwise indicated, all the glass transition temperature “Tg” values described herein are measured in a known manner by DSC (Differential Scanning calorimetry) according to the standard ASTM D3418 (1999).

### II—DESCRIPTION OF THE INVENTION

### II-1 Elastomer Matrix

According to the invention, the elastomer matrix comprises more than 50 phr of at least one copolymer containing ethylene units and 1,3-diene units, the ethylene units in the copolymer representing between 50 mol % and 95 mol % of the monomer units of the copolymer (referred to hereinbelow as the “copolymer”).

The term “copolymer containing ethylene units and 1,3-diene units” means any copolymer comprising, within its structure, at least ethylene units and 1,3-diene units. The copolymer may thus comprise monomer units other than ethylene units and 1,3-diene units. For example, the copolymer may also comprise α-olefin units, notably α-olefin units containing from 3 to 18 carbon atoms, advantageously containing 3 to 6 carbon atoms. For example, the α-olefin units may be chosen from the group consisting of propylene, butene, pentene, hexene or mixtures thereof.

In a known manner, the expression “ethylene unit” refers to the —(CH₂—CH₂)— unit resulting from the insertion of ethylene into the elastomer chain.

In a known manner, the expression “1,3-diene unit” refers to units resulting from the insertion of 1,3-diene via a 1,4 addition, a 1,2 addition or a 3,4 addition in the case of a substituted diene, for instance isoprene.

Preferably, the 1,3-diene units are chosen from the group consisting of butadiene units, isoprene units and mixtures of these 1,3-diene units. In particular, the 1,3-diene units of the copolymer may be 1,3-diene units containing 4 to 12 carbon atoms, for example 1,3-butadiene or 2-methyl-1,3-butadiene (or isoprene) units. More preferably, the 1,3-diene units are, to more than 50 mol %, or even preferentially exclusively 1,3-butadiene units.

In the copolymer, the ethylene units represent between 50 mol % and 95 mol % of the monomer units of the copolymer. Advantageously, the ethylene units in the copolymer represent between 55 mol % and 90 mol %, preferably from 60 mol % to 90 mol %, preferably from 70 mol % to 85 mol %, of the monomer units of the copolymer.

Advantageously, the copolymer is a copolymer of ethylene and of a 1,3-diene (preferably 1,3-butadiene), that is to say, according to the invention, a copolymer consisting exclusively of ethylene units and of 1,3-diene (preferably 1,3-butadiene) units.

When the copolymer is a copolymer of ethylene and of a 1,3-diene, said copolymer advantageously contains units of formula (I) and/or (II). The presence of a saturated 6-membered ring unit, 1,2-cyclohexanediyl, of formula (I) as a monomer unit in the copolymer may result from a series of very specific insertions of ethylene and of 1,3-butadiene into the polymer chain during its growth.

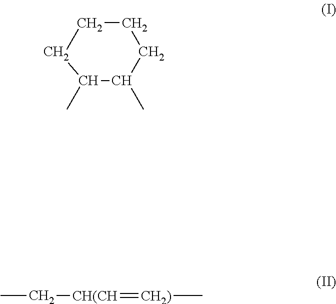

For example, the copolymer of ethylene and of a 1,3-diene may be free of units of formula (I). In this case, it preferably contains units of formula (II).

When the copolymer of ethylene and of a 1,3-diene comprises units of formula (I) or units of formula (II), or else units of formula (I) and units of formula (II), the molar percentages of the units of formula (I) and of the units of formula (II) in the copolymer, respectively o and p, preferably satisfy the following equation (eq. 1), more preferentially the equation (eq. 2), o and p being calculated on the basis of all the monomer units of the copolymer:

$$0 < o + p \leq 25 \qquad ( eq . 1 )$$

$$0 < o + p < 20 \qquad ( eq . 2 )$$

According to the invention, the copolymer, preferably the copolymer of ethylene and a 1,3-diene (preferably 1,3-butadiene), is a random copolymer.

Advantageously, the number-average mass (Mn) of the copolymer, preferably of the copolymer of ethylene and of a 1,3-diene (preferably of 1,3-butadiene), is in a range from 100 000 to 300 000 g/mol, preferably from 150 000 to 250 000 g/mol.

The Mn of the copolymer is determined, in a known manner, by size exclusion chromatography (SEC) as described in point IV-1 below.

The copolymer may be obtained according to various synthetic methods known to those skilled in the art, notably as a function of the targeted microstructure of the copolymer. Generally, it may be prepared by copolymerization at least of a diene, preferably a 1,3-diene, more preferably 1,3-butadiene, and of ethylene and according to known synthetic methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the Applicant. The copolymer, including the case when it is random, may also be prepared via a process using a catalytic system of preformed type such as those described in WO 2017/093654 A1, WO 2018/020122 A1 and WO 2018/020123 A1.

The copolymer may consist of a mixture of copolymers containing ethylene units and 1,3-diene units which differ from each other by virtue of their microstructures and/or their macrostructures.

According to the invention, the elastomer matrix may comprise at least one other diene elastomer, which is not the copolymer as defined above, but this is not necessary. Thus, preferentially, the content of the at least one copolymer is within a range extending from 60 to 100 phr, preferably from 80 to 100 phr. Advantageously, the at least one copolymer containing ethylene units and 1,3-diene units is the only elastomer of the composition, that is to say that it represents 100% by mass of the elastomer matrix.

The term “diene” elastomer (or, without distinction, rubber), whether natural or synthetic, should be understood, in a known manner, as meaning an elastomer consisting, at least partly (i.e. a homopolymer or a copolymer), of diene monomer units (monomers bearing two conjugated or non-conjugated carbon-carbon double bonds). This definition includes the copolymer containing ethylene units and 1,3-diene units.

When the elastomer matrix comprises at least one other diene elastomer which is not the copolymer containing ethylene units and 1,3-diene units, the at least one other elastomer may be chosen, for example, from the group consisting of polybutadienes (BRs), natural rubber (NR), synthetic polyisoprenes (IRs), butadiene copolymers, isoprene copolymers, and mixtures of these elastomers. The butadiene copolymers are particularly chosen from the group consisting of styrene/butadiene copolymers (SBRs).

### II-2 Reinforcing Filler

The composition according to the invention advantageously comprises a reinforcing filler, known for its abilities to reinforce a rubber composition that can be used for manufacturing tyres. Such a reinforcing filler typically consists of particles with a mean size (by mass) of less than a micrometer, generally less than 500 nm, most often between 20 and 200 nm, in particular and more preferentially between 20 and 150 nm.

The reinforcing filler may comprise carbon black, silica, or a mixture thereof. Advantageously, the reinforcing filler of the composition according to the invention comprises more than 50% by mass and preferably more than 80% by mass of carbon black. More preferably, the reinforcing filler consists exclusively of carbon black, that is to say that carbon black represents 100% by mass of the reinforcing filler.

The blacks which can be used in the context of the present invention can be any black conventionally used in tyres or their treads (“tyre-grade” blacks). Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. These carbon blacks may be used in isolated form, as commercially available, or in any other form, for example as support for some of the rubber engineering additives used. The carbon blacks might, for example, be already incorporated into the diene elastomer, notably an isoprene elastomer, in the form of a masterbatch (see, for example, patent applications WO 97/36724 and WO 99/16600).

Among the abovementioned carbon blacks, those having a BET specific surface area within a range extending from 100 to 160 m²/g, preferably from 124 to 150 m²/g, are particularly preferred.

The BET specific surface area of the carbon blacks is measured according to the standard D6556-2016 [multipoint (a minimum of 5 points) method—gas: nitrogen—relative pressure p/p₀ range: 0.1 to 0.3].

Any type of precipitated silica, notably highly dispersible precipitated silicas (referred to as “HDSs”), may be suitable as silicas. These precipitated silicas, which are or are not highly dispersible, are well known to a person skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. As non-HDS silicas, use may be made of the following commercial silicas: the Ultrasil® VN2GR and Ultrasil® VN3GR silicas from the company Evonik, the Zeosil® 175GR silica from the company Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from the company PPG.

In order to couple the silica to the diene elastomer, use may be made, in a well-known manner, of an at least difunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least difunctional. The term “difunctional” refers to a compound having a first functional group that is capable of interacting with the inorganic filler and a second functional group that is capable of interacting with the diene elastomer. For example, such a difunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, when they are used, the organosilanes are chosen from the group consisting of organosilane polysulfides (which may be symmetrical or asymmetrical) such as bis(3-triethoxysilylpropyl) tetrasulfide, abbreviated to TESPT, sold under the name Si69 by the company Evonik, or bis(triethoxysilylpropyl) disulfide, abbreviated to TESPD, sold under the name Si75 by the company Evonik, polyorganosiloxanes, mercaptosilanes, blocked mercaptosilanes, such as S-(3-(triethoxysilyl) propyl) octanethioate sold by the company Momentive under the name NXT Silane. More preferentially, the organosilane is an organosilane polysulfide.

When an agent for coupling the silica to the elastomer is used, the content of coupling agent can easily be adjusted by a person skilled in the art. Typically, the content of coupling agent represents from 0.5% to 15% by weight, with respect to the amount of silica.

The content of reinforcing filler can be readily adjusted by a person skilled in the art according to the use of the rubber composition. Advantageously, the content of reinforcing filler in the composition according to the invention is within a range extending from 10 to less than 100 phr, preferably from 15 to 90 phr.

Preferably, the content of carbon black in the composition according to the invention is within a range extending from 10 to less than 100 phr, preferably from 15 to 90 phr, and the composition does not comprise any filler other than carbon black or comprises less than 10 phr, preferably less than 5 phr, thereof; more preferably, the composition does not comprise any filler other than carbon black.

### II-3 Vulcanization System

The vulcanization system is by definition sulfur-based. It may comprise molecular sulfur and/or at least one sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retardants.

Sulfur is used in a preferential content of between 0.5 and 12 phr, in particular between 1 and 10 phr. The vulcanization accelerator is used in a preferential content of between 0.5 and 10 phr, more preferentially between 0.5 and 5.0 phr.

Use may be made, as accelerator, of any compound that is capable of acting as an accelerator of the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate types. As examples of such accelerators, mention may notably be made of the following compounds: 2-mercaptobenzothiazyl disulfide (abbreviated as MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### II-4 Epoxy Resin

The composition according to the invention comprises between 1 and 30 phr of epoxy resin. Epoxy resins are reinforcing resins (or curing resins) known to those skilled in the art for stiffening rubber compositions.

The epoxy resins that may be used in the present invention include all polyepoxide compounds. For example, the epoxy resin may be chosen from aromatic epoxy resins, alicyclic epoxy resins, and aliphatic epoxy resins. For example, the aromatic epoxy resin may be an aromatic amine epoxy resin. These resins are preferentially novolac epoxy resins, i.e. epoxy resins obtained by acid catalysis, as opposed to resol resins, which are obtained by basic catalysis.

In particular, among aromatic epoxide compounds, preference is given to epoxy resins chosen from the group consisting of 2,2-bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)] and mixtures of these compounds.

The epoxy resin is more preferably chosen from the group consisting of poly[(o-cresyl glycidyl ether)-co-formaldehyde], poly[(phenyl glycidyl ether)-co-formaldehyde], aromatic amine epoxy resins and mixtures of these compounds.

As example of commercially available epoxy resins that can be used in the context of the present invention, examples that may be mentioned include the epoxy resin DEN 439 from the company Uniqema, the epoxy resin tris(4-hydroxyphenyl) methane triglycidyl ether from the company Sigma-Aldrich or the epoxy cresol novolac resin Araldite ECN 1299 from the company Huntsman.

The amount of epoxy resin is between 1 and 30 phr. In view of the amine-based hardener used in the context of the present invention, below the minimum content of epoxy resin indicated, the targeted technical effect is insufficient whereas, above the maximum indicated, risks arise of an excessive increase in the stiffness and of excessive penalization of the hysteresis and the Mooney plasticity. For all these reasons, the content of epoxy resin is between 5 and 25 phr. More preferably, the content of epoxy resin in the composition according to the invention is between 10 and 20 phr.

### II-5 Amine-Based Hardener

The epoxy resin of the composition of the invention is combined with a specific amine-based hardener which enables the crosslinking of the resin.

According to the invention, the amine-based hardener comprises at least two primary amine functions located on at least one (i.e. one or more) six-membered aromatic ring, said at least one six-membered aromatic ring comprising:
at least one primary amine function, and
at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals,
   so that the at least one six-membered aromatic ring does not comprise a hydrogen atom located in the ortho position relative to the primary amine functions,
   said amine-based hardener comprising at least one second primary amine function located on said at least one six-membered aromatic ring or on a possible second six-membered aromatic ring of said amine-based hardener.

In other words, the amine-based hardener comprises one or more six-membered aromatic rings and at least two primary amine functions located on just one or distributed over several of these six-membered aromatic rings.

In a manner well known to those skilled in the art, the term “primary amine function” means an amine function in which the nitrogen atom is bonded to two hydrogen atoms.

The amine-based hardener preferably comprises from 1 to 3 and more preferably 1 or 2 six-membered aromatic rings.

The amine-based hardener preferably comprises from 2 to 4 and more preferably 2 primary amine functions located on at least one six-membered aromatic ring of the amine-based hardener.

Among the halogens capable of constituting the radicals Ri, mention may be made of fluorine, chlorine, bromine or iodine atoms. Preferably, the halogens are chosen from the group consisting of chlorine and bromine atoms; more preferably, the halogens are chlorine atoms.

According to a first embodiment of the present invention, the amine-based hardener may comprise a six-membered aromatic ring including:
at least two primary amine functions, and
at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals,
   such that said ring does not comprise a hydrogen atom located in the ortho position relative to the primary amine functions.

According to a second embodiment of the present invention, the amine-based hardener may also comprise at least two identical or different six-membered aromatic rings, said rings each including:
at least one primary amine function, and
at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals,
   such that said rings do not comprise a hydrogen atom located in the ortho position relative to the primary amine functions.

According to another embodiment, the amine-based hardener may also comprise several six-membered aromatic rings and at least two primary amine functions located solely on one of the aromatic rings.

When the amine-based hardener comprises several (i.e. at least two) six-membered aromatic rings, these rings may be identical or different. They can, for example, differ from each other in the nature of the atoms constituting said rings and/or in the number of primary amine functions located on said rings and/or in the nature and/or number of the radicals Ri positioned on said rings and/or in the position of the primary amine functions and radicals Ri on said rings. Preferably, when the amine-based hardener comprises several six-membered aromatic rings, these rings are identical.

As indicated above, the amine-based hardener comprises at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals. In the expression “ethers, tertiary amines, thioethers, ketones, esters and amides, substituted with linear or branched C₁-C₆ alkyl radicals”, a person skilled in the art clearly understands that the term “substituted with linear or branched C₁-C₆ alkyl radicals” relates to each of the ethers, tertiary amines, thioethers, ketones, esters and amides.

Whatever the embodiment of the present invention, the amine-based hardener preferentially comprises at least two radicals Ri, which may be identical or different, chosen from the group consisting of linear or branched C₁-C₆ alkyl radicals, halogens, ethers, tertiary amines and thioethers, substituted with linear or branched C₁-C₆ alkyl radicals. Preferably again, the amine-based hardener comprises at least two radicals Ri, which may be identical or different, chosen from the group consisting of linear or branched C₁-C₆ alkyl radicals, halogens and thioethers, substituted with linear or branched C₁-C₆ alkyl radicals.

Whatever the embodiment of the present invention, the radicals Ri, which may be identical or different, are preferably chosen from the group consisting of linear or branched C₁-C₆ alkyl radicals. In other words, all the radicals Ri of the amine-based hardener may be linear or branched C₁-C₆ alkyl radicals, the linear or branched C₁-C₆ alkyl radicals preferably being chosen from the group consisting of methyl, ethyl and propyl radicals.

Whatever the embodiment of the present invention, the at least one six-membered aromatic ring of the amine-based hardener may comprise at least two radicals Ri, which may be identical or different, chosen from the group consisting of halogens, ethers, tertiary amines and thioethers, substituted with linear or branched C₁-C₆ alkyl radicals, and at least one radical Ri chosen from the group consisting of linear or branched C₁-C₆ alkyl radicals.

Whatever the embodiment of the present invention, whether the radicals Ri or the radicals of the ethers, tertiary amines, thioethers, ketones, esters or amides are concerned, the linear or branched C₁-C₆ alkyl radicals may be chosen from the group consisting of methyl, ethyl, propyl, isopropyl, isobutyl and butyl radicals. Preferably, the linear or branched C₁-C₆ alkyl radicals are chosen from the group consisting of methyl, ethyl and propyl radicals. Preferably again, the linear or branched C₁-C₆ alkyl radicals are chosen from the group consisting of methyl and ethyl radicals.

Whatever the embodiment of the present invention, the atoms in the aromatic rings of the amine-based hardener may be carbon atoms, and may optionally comprise nitrogen atoms. Preferably, all the atoms in the aromatic rings of the amine-based hardener are carbon atoms. In other words, the six-membered aromatic rings of the amine-based hardener are preferentially aromatic rings containing six carbon atoms.

In formulae (III) to (VII) presented below, it should be recalled that the radicals Ri may be identical or different.

According to the first embodiment of the present invention, the amine-based hardener may correspond to formula (III):

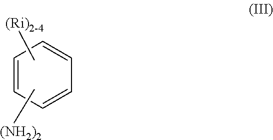

Preferably, according to this embodiment, the amine-based hardener corresponds to formula (IV):

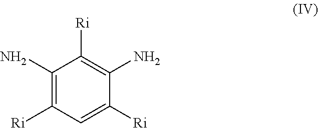

According to the second embodiment of the present invention, the amine-based hardener may also correspond to formula (V):

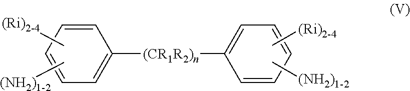

in which:
n represents an integer ranging from 0 to 4, preferably from 1 to 3,
R₁ and R₂, which may be identical or different, are chosen from the group consisting of a hydrogen atom and a methyl, ethyl, isobutyl or benzyl group; preferably, R₁ and R₂ both represent a hydrogen atom.

Preferably, according to this embodiment, the amine-based hardener corresponds to formula (VI):

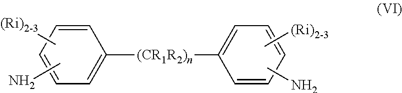

in which:
n represents 1 or 2, preferably 1,
R₁ and R₂, which may be identical or different, are chosen from the group consisting of a hydrogen atom and a methyl, ethyl, isobutyl or benzyl group; preferably, R₁ and R₂ both represent a hydrogen atom.

Preferably again, according to this embodiment, the amine-based hardener corresponds to formula (VII):

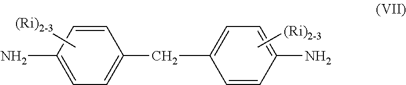

Very preferentially, according to the invention, the amine-based hardener is chosen from the group consisting of the compounds of formulae (VIII) to (XIII) below and mixtures of these compounds:

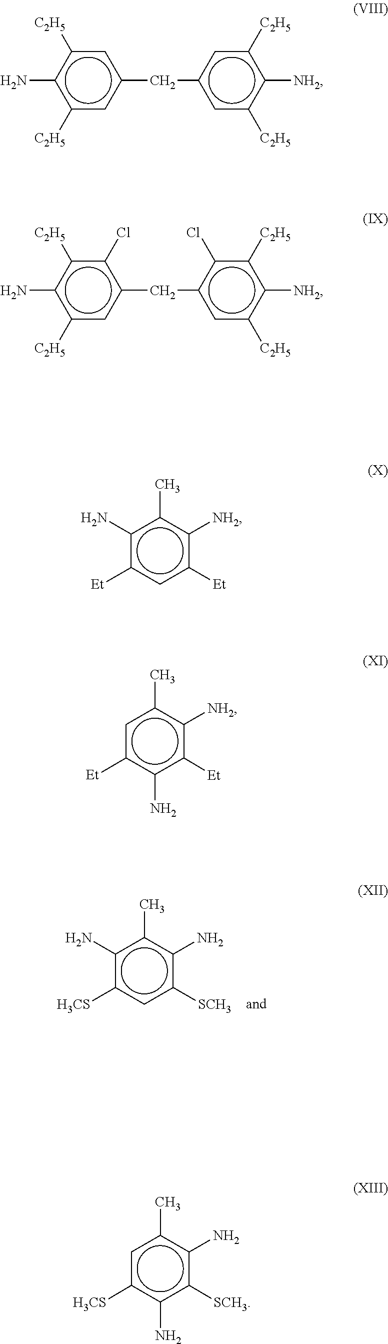

As examples of commercially available amine-based hardeners that can be used in the context of the present invention, examples that may be mentioned include Ethacure 100 or Ethacure 300 from the company Albemarle and Lonzacure DETDA, Lonzacure MDEA or Lonzacure MCDEA from the company Lonza.

The amount of amine-based hardener is between 1 and 15 phr. Below the minimum indicated, the targeted technical effect has proven to be insufficient whereas, above the maximum indicated, risks arise of the processing in the raw state of the compositions being disadvantaged. Advantageously, the content of amine-based hardener is within a range extending from 5 to 10 phr, preferably from 2 to 8 phr.

### II-6 Possible Additives

The rubber compositions according to the invention may optionally also include all or some of the usual additives customarily used in elastomer compositions for tyres, for instance plasticizers (such as plasticizing oils and/or plasticizing resins), reinforcing or non-reinforcing fillers other than those mentioned above, pigments, protective agents such as anti-ozone waxes, chemical anti-ozonants, antioxidants and anti-fatigue agents.

Advantageously, the composition according to the invention comprises a condensation accelerator, which is particularly advantageous for reducing the curing time of the composition.

Thus, the composition according to the invention advantageously comprises an imidazole of general formula (XIV):

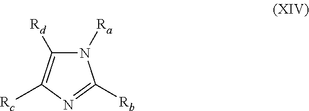

in which:
   Rₐ represents a hydrogen atom or a hydrocarbon-based group which is optionally interrupted with one or more heteroatoms and/or substituted,
   R_{b} represents a hydrocarbon-based group,
   R_{c} and R_{d} represent, independently of each other, a hydrogen atom or a hydrocarbon-based group which is optionally interrupted with one or more heteroatoms and/or substituted,
   or else R_{c} and R_{d} form, together with the carbon atoms of the imidazole ring to which they are attached, a ring which is optionally interrupted with one or more heteroatoms and/or substituted.

The expression “optionally interrupted with one or more heteroatoms and/or substituted” means that the groups Rₐ, R_{c} and R_{d} can, independently and when they represent a hydrocarbon-based group, be interrupted with a heteroatom (that is to say, in other words, that a heteroatom is inserted into the hydrocarbon-based chain), preferentially chosen from nitrogen, oxygen and sulfur, and/or substituted with a functional group. The term “functional group” means a group comprising a heteroatom, preferentially chosen from amino, alkylamine, alkoxyl and hydroxyl groups, preferentially chosen from hydroxyl and amino groups.

The term “amino group” means a group of formula —NH₂. The term “hydroxyl group” means a group of formula —OH.

Preferably, the imidazole of general formula (XIV) has groups such that:
Rₐ is chosen from the group consisting of a hydrogen atom, alkyl groups containing from 1 to 20 carbon atoms, cycloalkyl groups containing from 5 to 24 carbon atoms, aryl groups containing from 6 to 30 carbon atoms, and aralkyl groups containing from 7 to 25 carbon atoms, which are optionally substituted,
R_{b} is chosen from the group consisting of alkyl groups containing from 1 to 20 carbon atoms, cycloalkyl groups containing from 5 to 24 carbon atoms, aryl groups containing from 6 to 30 carbon atoms, and aralkyl groups containing from 7 to 25 carbon atoms,
R_{c} and R_{d} are independently chosen from the group consisting of a hydrogen atom or alkyl groups containing from 1 to 20 carbon atoms, cycloalkyl groups containing from 5 to 24 carbon atoms, aryl groups containing from 6 to 30 carbon atoms or aralkyl groups containing from 7 to 25 carbon atoms, which are optionally substituted; or else R_{c} and R_{d} form, together with the carbon atoms of the imidazole ring to which they are attached, a ring chosen from aromatic, heteroaromatic or aliphatic rings comprising from 5 to 12 carbon atoms, preferably 5 or 6 carbon atoms.

Preferentially, Rₐ is chosen from the group consisting of alkyl groups containing from 2 to 12 carbon atoms and aralkyl groups containing from 7 to 13 carbon atoms, which are optionally substituted. More preferentially, Rₐ is chosen from the group consisting of aralkyl groups containing from 7 to 13 carbon atoms, which are optionally substituted, and R_{b} is chosen from the group consisting of alkyl groups containing from 1 to 12 carbon atoms. Even more preferentially, Rₐ is chosen from the group consisting of aralkyl groups containing from 7 to 11 carbon atoms, which are optionally substituted, and R_{b} is chosen from the group consisting of alkyl groups containing from 1 to 4 carbon atoms.

Preferably, R_{c} and R_{d} are independently chosen from the group consisting of a hydrogen atom and alkyl groups containing from 1 to 12 carbon atoms, cycloalkyl groups containing from 5 to 8 carbon atoms, aryl groups containing from 6 to 24 carbon atoms and aralkyl groups containing from 7 to 13 carbon atoms. Alternatively and preferentially also, R_{c} and R_{d} form, with the carbon atoms of the imidazole ring to which they are attached, a phenyl, cyclohexene or cyclopentene ring.

Very preferably, R_{c} and R_{d} represent a hydrogen atom, Rₐ and R_{b} being chosen as described previously.

In a preferred arrangement, Rₐ is a naphthylalkyl group comprising from 11 to 13 carbon atoms, optionally substituted with at least one hydroxyl group, R_{b} is an alkyl group containing from 1 to 4 carbon atoms, R_{c} and R_{d} are independently chosen from the group consisting of a hydrogen atom and alkyl groups containing from 1 to 12 carbon atoms. The term “naphthylalkyl group” means a group of general formula (XV), where n represents an integer between 1 and 3:

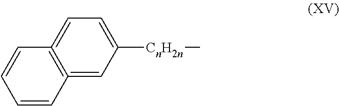

Preferentially, Rₐ is a naphthylalkyl group comprising from 11 to 13 carbon atoms substituted with at least one hydroxyl group, R_{b} is an alkyl group containing from 1 to 3 carbon atoms, R_{c} and R_{d} are a hydrogen atom. Very preferably, Rₐ is a 2-naphthol-1-methyl group, R_{b} is a methyl group, R. and Rₐ are hydrogen atoms, compound (XIV) then corresponding to formula (XVI):

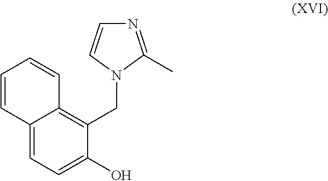 [SMILES: Cc1nccn1Cc1c(O)ccc2ccccc12]

The rubber composition according to the invention preferentially comprises from 0.1 to 5 phr of imidazole of general formula (XIV). Below this minimum content, the technical effect is not significant, whereas above these contents, the imidazole of general formula (XIV) could compete with the amine-based hardener and modify the network obtained during crosslinking. Preferably, the composition comprises 0.1 to 3 phr, preferably 0.2 to 3 phr, preferably 0.2 to 2 phr of imidazole of general formula (XIV).

The imidazoles that may be used in the context of the invention are either commercially available or can be readily prepared by those skilled in the art using well-known techniques such as those described, for example, in documents JP2012211122, JP2007269658 or else in Science of Synthesis 2002, 12, 325-528.

For example, as commercially available imidazoles that may be used for the purposes of the invention, mention may be made of 1,2-dimethylimidazole, 1-decyl-2-methylimidazole, 1-benzyl-2-methylimidazole or 1-((2-methyl-1H-imidazol-1-yl)methyl) naphthalen-2-ol commercially available under the name Aradur 3123 from the company Huntsman.

### II-7 Preparation of the Rubber Compositions

The compositions in accordance with the invention may be manufactured in appropriate mixers using two successive preparation phases that are well known to those skilled in the art:
a first phase of thermomechanical working or kneading (known as the “non-productive” phase), that can be performed in a single thermomechanical step during which all the necessary constituents, notably the elastomer matrix, the reinforcing filler, the epoxy resin and the various other optional additives, with the exception of the vulcanization system, the amine-based hardener and the optional condensation accelerator, are introduced into an appropriate mixer, such as a standard internal mixer (for example of Banbury type). The incorporation of the optional filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the various other optional additives, with the exception of the vulcanization system, are incorporated. The non-productive phase may be performed at high temperature, up to a maximum temperature of between 110° C. and 200° C., preferably between 130° C. and 185° C., for a period of time generally of between 2 and 10 minutes.
a second phase of mechanical working (known as the “productive” phase), which may be performed in an external mixer, such as an open mill, after cooling the mixture obtained during the first non-productive phase down to a lower temperature, typically below 120° C., for example between 40° C. and 100° C. The vulcanization system is then incorporated and the combined mixture is then mixed for a few minutes, for example between 5 and 15 min.

Such phases have been described, for example, in patent applications EP-A-0501227, EP-A-0735088, EP-A-0810258, WO 00/05300 or WO 00/05301.

The final composition thus obtained is then calendered, for example in the form of a sheet or of a slab, notably for laboratory characterization, or else is extruded (or co-extruded with another rubber composition) in the form of a semi-finished rubber product (or profiled element) that may be used, for example, as an internal layer of a tyre. These products may then be used for the manufacture of tyres, according to the techniques known to those skilled in the art.

The composition may be either in the green state (before crosslinking or vulcanization) or in the cured state (after crosslinking or vulcanization), or may be a semi-finished product which can be used in a tyre.

The composition may be crosslinked in a manner known to those skilled in the art, for example at a temperature of between 130° C. and 200° C., under pressure.

### II-8 Rubber Article

The present invention also relates to a rubber article comprising at least one composition according to the invention. Preferably, the rubber article is a tyre.

More particularly, a subject of the invention is also a pneumatic or non-pneumatic tyre provided with at least one internal layer comprising a composition according to the invention. The composition according to the invention may constitute all or part of the internal layer of the tyre. The internal layer is preferably chosen from the group consisting of carcass plies, crown plies, bead fillers, crown butts, decoupling layers, edge rubbers, filling rubbers, the tread underlayer and combinations of these internal layers. More preferably, the internal layer is chosen from the group consisting of bead fillers, crown butts, tread underlayers and combinations of these internal layers. More preferably, the internal layer is chosen from the group consisting of bead fillers, crown butts and a combination of these internal layers.

The tyre according to the invention may be intended to equip any type of vehicle, in particular motor vehicles, without any particular limitation.

### III—PREFERRED EMBODIMENTS

In the light of the foregoing, the preferred embodiments of the invention are described below:
1. Rubber composition based on at least:
   an elastomer matrix comprising more than 50 phr of at least one copolymer containing ethylene units and 1,3-diene units, the ethylene units in the copolymer representing between 50 mol % and 95 mol % of the monomer units of the copolymer,
   a reinforcing filler,
   a vulcanization system,
   from 1 to 30 phr of epoxy resin,
   between 1 and 15 phr of an amine-based hardener comprising at least two primary amine functions located on at least one six-membered aromatic ring, said at least one six-membered aromatic ring comprising:
      at least one primary amine function, and
      at least two radicals Ri, which may be identical or different, chosen from the group consisting of linear or branched C₁-C₆ alkyl radicals, halogens, ethers, tertiary amines, thioethers, ketones, esters and amides, substituted with linear or branched C₁-C₆ alkyl radicals,
         so that the at least one six-membered aromatic ring does not comprise a hydrogen atom located in the ortho position relative to the primary amine functions,
         said amine-based hardener comprising at least one second primary amine function located on said at least one six-membered aromatic ring or on a possible second six-membered aromatic ring of said amine-based hardener.
2. Rubber composition according to embodiment 1, wherein the ethylene units in the copolymer represent between 55 mol % and 90 mol % of the monomer units of the copolymer.
3. Rubber composition according to either of the preceding embodiments, wherein the copolymer containing ethylene units and 1,3-diene units is a copolymer of ethylene and of 1,3-diene.
4. Rubber composition according to any one of the preceding embodiments, wherein the 1,3-diene is 1,3-butadiene.
5. Rubber composition according to any one of the preceding embodiments, wherein the copolymer contains units of formula (I) or units of formula (II) or else units of formula (I) and of formula (II):

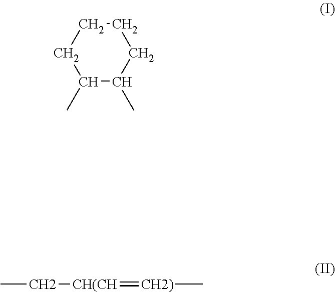

6. Rubber composition according to embodiment 5, wherein the molar percentages of the units of formula (1) and the units of formula (2) in the copolymer, o and p, respectively, satisfy the following equation (eq. 1), preferentially the equation (eq. 2), o and p being calculated on the basis of all the monomer units of the copolymer:

$$0 < o + p \leq 25 \qquad ( eq . 1 )$$

$$0 < o + p < 20 \qquad ( eq . 2 )$$

7. Rubber composition according to any one of the preceding embodiments, wherein the copolymer containing ethylene units and 1,3-diene units is a random copolymer.
8. Rubber composition according to any one of the preceding embodiments, wherein the content of the copolymer containing ethylene units and 1,3-diene units is within a range extending from 60 to 100 phr, preferably from 80 to 100 phr.
9. Rubber composition according to any one of the preceding embodiments, wherein the epoxy resin is chosen from aromatic epoxy, alicyclic epoxy and aliphatic epoxy resins.
10. Rubber composition according to any one of embodiments 1 to 8, wherein the epoxy resin is chosen from the group consisting of 2,2-bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)] and mixtures of these compounds.
11. Rubber composition according to any one of the preceding embodiments, wherein the content of epoxy resin is between 5 and 25 phr, preferably between 10 and 20 phr.
12. Rubber composition according to any one of the preceding embodiments, wherein the radicals Ri, which may be identical or different, are chosen from the group consisting of linear or branched C₁-C₆ alkyl radicals, halogens, ethers, tertiary amines and thioethers, substituted with linear or branched C₁-C₆ alkyl radicals.
13. Rubber composition according to any one of the preceding embodiments, wherein the radicals Ri, which may be identical or different, are chosen from the group consisting of linear or branched C₁-C₆ alkyl radicals.
14. Rubber composition according to any one of embodiments 1 to 12, wherein the at least one six-membered aromatic ring of the amine-based hardener comprises at least two radicals Ri, which may be identical or different, chosen from the group consisting of halogens, ethers, tertiary amines and thioethers, substituted with linear or branched C₁-C₆ alkyl radicals, and at least one radical Ri chosen from the group consisting of linear or branched C₁-C₆ alkyl radicals.
15. Rubber composition according to any one of the preceding embodiments, wherein the linear or branched C₁-C₆ alkyl radicals are chosen from the group consisting of methyl, ethyl, propyl, isopropyl, isobutyl and butyl radicals, preferably from the group consisting of methyl and ethyl radicals.
16. Rubber composition according to any one of the preceding embodiments, wherein the at least one six-membered aromatic ring is an aromatic ring containing six carbon atoms.
17. Rubber composition according to any one of the preceding embodiments, wherein the amine-based hardener corresponds to formula (III):

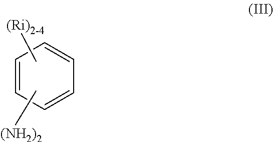

18. Rubber composition according to any one of embodiments 1 to 16, wherein the amine-based hardener corresponds to formula (IV):

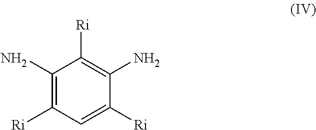

19. Rubber composition according to any one of embodiments 1 to 16, wherein the amine-based hardener corresponds to formula (V):

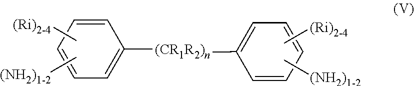

in which:
n represents an integer ranging from 0 to 4, preferably from 1 to 3,
R₁ and R₂, which may be identical or different, are chosen from the group consisting of a hydrogen atom and a methyl, ethyl, isobutyl or benzyl group; preferably, R₁ and R₂ both represent a hydrogen atom.
20. Rubber composition according to any one of embodiments 1 to 16 or 19, wherein the amine-based hardener corresponds to formula (VI):

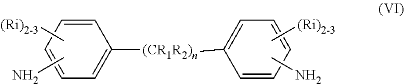

in which:
n represents 1 or 2, preferably 1,
R₁ and R₂, which may be identical or different, are chosen from the group consisting of a hydrogen atom and a methyl, ethyl, isobutyl or benzyl group; preferably, R₁ and R₂ both represent a hydrogen atom.
21. Rubber composition according to any one of embodiments 1 to 16, wherein the amine-based hardener corresponds to formula (VII):

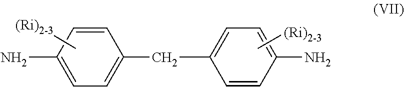

22. Rubber composition according to any one of embodiments 1 to 16, wherein the amine-based hardener is chosen from the group consisting of the compounds of formulae (VIII) to (XIII) below and mixtures of these compounds:

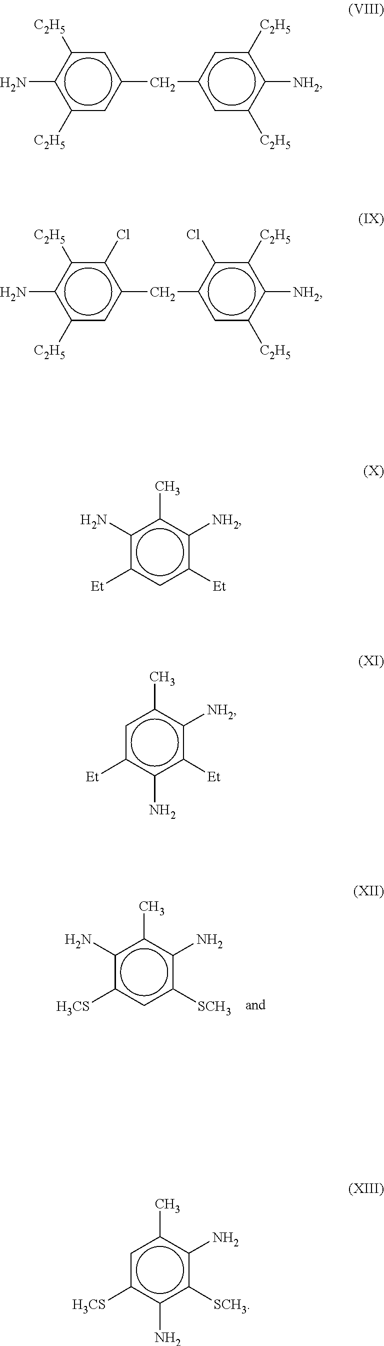

23. Rubber composition according to any one of the preceding embodiments, wherein the content of amine-based hardener is within a range extending from 5 to 10 phr, preferably from 2 to 8 phr.
24. Rubber composition according to any one of the preceding embodiments, also comprising an imidazole of formula (XIV):

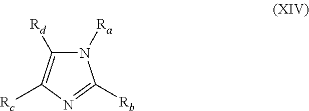

in which:
   Ra represents a hydrogen atom or a hydrocarbon-based group which is optionally interrupted with one or more heteroatoms and/or substituted,
   Rb represents a hydrocarbon-based group,
   Rc and Rd represent, independently of each other, a hydrogen atom or a hydrocarbon-based group which is optionally interrupted with one or more heteroatoms and/or substituted,
   or else Rc and Rd form, together with the carbon atoms of the imidazole ring to which they are attached, a ring which is optionally interrupted with one or more heteroatoms and/or substituted.
25. Rubber composition according to embodiment 24, wherein, in the imidazole of formula (XIV):
   Rₐ is chosen from the group consisting of a hydrogen atom, alkyl groups containing from 1 to 20 carbon atoms, cycloalkyl groups containing from 5 to 24 carbon atoms, aryl groups containing from 6 to 30 carbon atoms, and aralkyl groups containing from 7 to 25 carbon atoms, which are optionally substituted,
   R_{b} is chosen from the group consisting of alkyl groups containing from 1 to 20 carbon atoms, cycloalkyl groups containing from 5 to 24 carbon atoms, aryl groups containing from 6 to 30 carbon atoms, and aralkyl groups containing from 7 to 25 carbon atoms,
   R_{c} and R_{d} are independently chosen from the group consisting of a hydrogen atom or alkyl groups containing from 1 to 20 carbon atoms, cycloalkyl groups containing from 5 to 24 carbon atoms, aryl groups containing from 6 to 30 carbon atoms or aralkyl groups containing from 7 to 25 carbon atoms, which are optionally substituted; or else Re and Rd form, together with the carbon atoms of the imidazole ring to which they are attached, a ring chosen from aromatic, heteroaromatic or aliphatic rings comprising from 5 to 12 carbon atoms, preferably 5 or 6 carbon atoms.
26. Rubber composition according to either of embodiments 24 and 25, wherein, in the imidazole of formula (XIV), Rₐ is chosen from the group consisting of alkyl groups containing from 2 to 12 carbon atoms and aralkyl groups containing from 7 to 13 carbon atoms, which are optionally substituted.
27. Rubber composition according to any one of embodiments 24 to 26, wherein, in the imidazole of formula (XIV), Rₐ is chosen from the group consisting of aralkyl groups containing from 7 to 13 carbon atoms, which are optionally substituted, and R_{b} is chosen from the group consisting of alkyl groups containing from 1 to 12 carbon atoms.
28. Rubber composition according to any one of embodiments 24 to 27, wherein, in the imidazole of formula (XIV), Rₐ is chosen from the group consisting of aralkyl groups containing from 7 to 11 carbon atoms, which are optionally substituted, and R_{b} is chosen from the group consisting of alkyl groups containing from 1 to 4 carbon atoms.
29. Rubber composition according to any one of embodiments 24 to 28, wherein, in the imidazole of formula (XIV), R_{c} and R_{d} are independently chosen from the group consisting of a hydrogen atom and alkyl groups containing from 1 to 12 carbon atoms, cycloalkyl groups containing from 5 to 8 carbon atoms, aryl groups containing from 6 to 24 carbon atoms and aralkyl groups containing from 7 to 13 carbon atoms, R. and Rₐ very preferentially being a hydrogen atom.
30. Rubber composition according to any one of embodiments 24 to 28, wherein, in the imidazole of formula (XIV), R_{c} and R_{d} form, with the carbon atoms of the imidazole ring to which they are attached, a phenyl, cyclohexene or cyclopentene ring.
31. Rubber composition according to embodiment 24, wherein, in the imidazole of formula (XIV), Rₐ is a naphthylalkyl group comprising from 11 to 13 carbon atoms, optionally substituted with at least one hydroxyl group, R_{b} is an alkyl group containing from 1 to 4 carbon atoms, R_{c} and R_{d} are independently chosen from the group consisting of a hydrogen atom and alkyl groups containing from 1 to 12 carbon atoms.
32. Rubber composition according to embodiment 31, wherein Rₐ is a naphthylalkyl group comprising from 11 to 13 carbon atoms substituted with at least one hydroxyl group, R_{b} is an alkyl group containing from 1 to 3 carbon atoms, R_{c} and R_{d} are a hydrogen atom, and wherein preferentially Rₐ is a 2-naphtholmethyl group, R_{b} is a methyl group, R_{c} and R_{d} are a hydrogen atom, compound (XIV) then corresponding to formula (XVI):

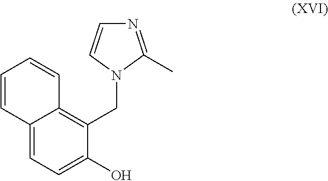 [SMILES: Cc1nccn1Cc1c(O)ccc2ccccc12]

33. Rubber composition according to any one of embodiments 24 to 32, wherein the content of imidazole of formula (XIV) is within a range extending from 0.1 to 5 phr, preferably from 0.1 to 3 phr.
34. Rubber composition according to any one of the preceding embodiments, wherein the reinforcing filler comprises carbon black, silica or a mixture thereof.
35. Rubber composition according to any one of the preceding embodiments, wherein the reinforcing filler comprises more than 50% by weight and preferably more than 80% by weight of carbon black.
36. Rubber composition according to either of embodiments 34 and 35, wherein the carbon black has a BET specific surface area in a range extending from 100 to 160 m²/g, preferably from 124 to 150 m²/g.
37. Rubber composition according to any one of the preceding embodiments, wherein the content of the reinforcing filler is within a range extending from 10 phr to less than 100 phr, preferably from 15 to 90 phr.
38. Rubber article comprising a composition as defined in any one of embodiments 1 to 37.
39. Tyre comprising a composition as defined in any one of embodiments 1 to 37.
40. Tyre according to embodiment 39, wherein the composition defined in any one of embodiments 1 to 37 is present in at least one internal layer, preferably chosen from the group consisting of carcass plies, crown plies, bead fillers, crown butts, decoupling layers, edge rubbers, filling rubbers, the tread underlayer and combinations of these internal layers.

### IV—EXAMPLES

### IV-1 Measurements and Tests Used

### Mechanical Properties

These tensile tests make it possible to determine the elasticity stresses and the properties at break. Processing of the tensile recordings also makes it possible to plot the curve of modulus as a function of the elongation, the modulus used here being the nominal (or apparent) secant modulus measured on first elongation, calculated by reducing to the initial cross section of the test specimen. The breaking stresses (BS in MPa) and the elongations at break (EB in %) are measured, at 23° C.±2° C., according to the standard NF T 46-002 of September 1988. The breaking energy is equal to the product of the elongation at break multiplied by the breaking stress.

The elongation at break results are expressed as a percentage on a basis of 100 relative to the control composition T1 or T2, depending on the case. A result greater than 100 indicates an improvement in the mechanical properties of the composition under consideration.

The dynamic properties G* and tan (8) max are measured on a viscosity analyser (Metravib VA4000) according to the standard ASTM D5992-96. The response of a sample of vulcanized composition (cylindrical test specimen with a thickness of 2 mm and a cross section of 79 mm²), subjected to a simple alternating sinusoidal shear stress, at a frequency of 10 Hz, at 60° C., according to ASTM standard D 1349-09, is recorded. A strain amplitude sweep is performed from 0.01% to 50% (outward cycle) and then from 50% to 0.01% (return cycle).

The results used are the complex dynamic shear modulus G* and the loss factor tan (8) max. On the outward cycle, the value of G* at 5% strain, and the loss factor, denoted tan (8) max, are recorded.

The results for G* at 5% strain on the outward cycle and for tan (8) max at 60° C. on the outward cycle are expressed as performance on a basis of 100, the value 100 being assigned to the control T1 or T2, depending on the case. A result greater than 100 indicates that the composition of the example under consideration is, respectively, stiffer and has lower hysteresis, which are respectively reflected by better stiffness for the application under consideration and lower hysteresis.

### Determination of the Microstructure of the Elastomers by Nuclear Magnetic Resonance (NMR):

The microstructure of the ethylene-butadiene copolymers is determined by ¹H NMR analysis, assisted by ¹³C NMR analysis when the resolution of the 1H NMR spectra does not make it possible to assign and quantify all the species. The measurements are performed using a Bruker 500 MHz NMR spectrometer at frequencies of 500.43 MHz for proton observation and 125.83 MHz for carbon observation. For the elastomers which are insoluble but which have the ability to swell in a solvent, an HRMAS 4 mm z-grad probe, which makes it possible to observe the protons and the carbons in proton-decoupled mode, is used. The spectra are acquired at spin speeds of 4000 Hz to 5000 Hz. For the measurements on soluble elastomers, a liquid NMR probe, which makes it possible to observe the protons and the carbons in proton-decoupled mode, is used. The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra with a sufficient sensitivity and resolution. The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by a person skilled in the art. In both cases (soluble sample or swollen sample): for proton NMR, a 30° single pulse sequence is used. The spectral window is adjusted to observe all the resonance lines belonging to the molecules analysed. The number of accumulations is set so as to obtain a signal-to-noise ratio that is sufficient for quantification of each unit. The recycle delay between each pulse is adapted to obtain a quantitative measurement. For carbon NMR, a simple 30° pulse sequence is used with proton decoupling only during the acquisition in order to avoid the “nuclear Overhauser” effects (NOE) and to remain quantitative. The spectral window is adjusted to observe all the resonance lines belonging to the molecules analysed. The number of accumulations is set so as to obtain a signal-to-noise ratio that is sufficient for quantification of each unit. The recycle delay between each pulse is adapted to obtain a quantitative measurement. The NMR measurements are performed at 25° C.

### Determination of the Macrostructure of the Polymers by Size Exclusion Chromatography (SEC):

Size exclusion chromatography (SEC) makes it possible to fractionate polymer chains in a solvent based on their hydrodynamic volume. Like all chromatographic systems, the technique is based on the elution of a solute (the polymer) through a column containing a stationary phase. The system is composed, in this order, of: a solvent reservoir, a pump system, an injector, a set of columns and detectors. The measurement system is equipped with a Waters Alliance e2695 module and a Waters fRI410 refractometer.

The mobile phase is eluted at a flow rate of 1 ml/min. The polymer is dissolved in THF in the presence of 1 wt % of diisopropylamine and 1 wt % of triethylamine at a concentration of 1 g/L. A volume of 100 μl is injected through a set of 3 size exclusion chromatography columns of the brand Agilent (Mixed B LS). The columns are thermostatically maintained at 35° C. in an oven. The stationary phase of the columns is based on a polystyrene/divinylbenzene gel having a controlled porosity. The polymer chains are separated based on the hydrodynamic volume that they occupy when they are dissolved in the solvent. The greater the volume they occupy, the less the pores of the columns are accessible to them, and the shorter their elution time. Detection is performed by a refractometer (RI) thermostatically maintained at 35° C. Each elution volume is associated with a mass via Moore calibration (calibrating against certified standards: polystyrene standards from Polymer Standard Service (Mainz)). The Waters Empower software is used for data acquisition and analysis. It is then possible to determine the number-average molar mass (Mn), the weight-average molar mass (Mw), and also the dispersity (PI=Mw/Mn).

### Mooney ML 1+4

For the polymers and rubber compositions, the Mooney viscosities ML (1+4) at 100° C. are measured using an oscillating consistometer according to the standard ASTM D-1646 (1999). The Mooney plasticity measurement is performed according to the following principle: the composition in the green state (i.e., before curing) is moulded in a cylindrical chamber heated to 100° C. After preheating for one minute, the rotor rotates within the specimen at 2 rpm and the working torque to maintain this movement is measured after rotation for 4 minutes. The Mooney plasticity ML (1+4) is expressed in “Mooney units” (MU, with 1 MU=0.83 N·m).

### IV-2 Synthesis of the Copolymer E1:

In the synthesis of polymers, all the reagents are obtained commercially except for the metallocenes. The butyloctylmagnesium BOMAG (20% in heptane, C=0.88 mol·l⁻¹) is obtained from Chemtura and is stored in a Schlenk tube under an inert atmosphere. The ethylene, of N35 grade, is obtained from the company Air Liquide and is used without prior purification.

The copolymer of ethylene and of 1,3-butadiene: elastomer E1 (in accordance with the invention) is synthesized according to the procedure described below.

To a reactor containing, at 80° C., methylcyclohexane, and also ethylene (Et) and butadiene (Bd) in the proportions indicated in Table 1, butyloctylmagnesium (BOMAG) is added to neutralize the impurities in the reactor, then the catalytic system is added (see Table 1). At this moment, the reaction temperature is regulated at 80° C. and the polymerization reaction starts. The polymerization reaction takes place at a constant pressure of 8 bar. The reactor is fed throughout the polymerization with ethylene and butadiene (Bd) in the proportions defined in Table 1. The polymerization reaction is stopped by cooling, degassing the reactor and adding ethanol. An antioxidant is added to the polymer solution. The copolymer is recovered by drying in a vacuum oven to constant mass. The catalyst system is a preformed catalyst system. It is prepared in methylcyclohexane from a metallocene, [Me₂SiFlu₂Nd(μ-BH₄)₂Li(THF)], a co-catalyst, butyloctylmagnesium (BOMAG), and a preformation monomer, 1,3-butadiene, in the contents indicated in Table 1. It is prepared according to a preparation method in accordance with section II.1 of patent application WO 2017/093654 A1.

The microstructure of copolymer E1 and the properties thereof are shown in Tables 2 and 3. For the microstructure, Table 2 indicates the mole ratios of the ethylene (Eth) units, of the 1,3-butadiene units, and of the 1,2-cyclohexanediyl (ring) units.

TABLE 1

| Synthesis | E1 |
|---|---|
| Metallocene concentration (mmol/l) | 0.07 |
| Alkylating agent concentration (mmol/l) | 0.36 |
| Preformation monomer/Nd metal mole ratio | 90 |
| Feed composition (mol % Et/Bd) | 80/20 |

TABLE 2

| Elastomer | E1 |
|---|---|
| Ethylene (mol %) | 77 |
| 1,3-Butadiene (mol %) | 15 |
| 1,2-Cyclohexanediyl (mol %) | 8 |

TABLE 3

| Elastomer | E1 |
|---|---|
| Tg (° C.) | −40 |
| Mn (g/mol) | 177 000 |
| Mooney (ML (1 + 4)) | 80 |
| at 100° C. | |

### IV-3 Preparation of the Compositions

In the examples that follow, the rubber compositions were produced as described in point II-7 above. In particular, the “non-productive” phase was performed in a 0.4 litre mixer for 3.5 minutes, at an average paddle speed of 50 rpm, until a maximum drop temperature of 165° C. was reached. The “productive” phase was performed in a cylinder tool at 40° C. for 5 minutes.

The crosslinking of the composition was performed at a temperature of between 130° C. and 200° C., under pressure.

### IV-4 Tests on Rubber Compositions

The object of the examples presented below is to compare the compromise in performance between the stiffness, hysteresis and mechanical properties (elongation at break and breaking stress) of a composition in accordance with the present invention (C1) with three control compositions (T1 to T3).

The compositions tested (in phr) and the results obtained are presented in Table 4.

Composition C1 differs from the control composition T1 only in the nature of the copolymer based on butadiene and on styrene. The control compositions T2 and T3 allow the impact of the absence of the curing system based on epoxy resin and amine-based hardener to be studied.

The results of composition C1 are expressed as a percentage on a basis of 100 relative to control composition T1, and the results of composition T3 are expressed as a percentage on a basis of 100 relative to the control composition T2.

TABLE 4

| Compositions | T1 | C1 | T2 | T3 |
|---|---|---|---|---|
| NR(1) | 100 | — | 100 | — |
| Elastomer E1 (2) | — | 100 | — | 100 |
| N115(3) | 60 | 60 | 60 | 60 |
| Curing resin (4) | 19.5 | 19.5 | — | — |
| Hardener (5) | 4.4 | 4.4 | — | — |
| 6PPD (6) | 2.0 | 2.0 | 2.0 | 2.0 |
| Stearic acid (7) | 1.0 | 1.0 | 1.0 | 1.0 |
| ZnO (8) | 2.7 | 2.7 | 2.7 | 2.7 |
| Sulfur | 5.0 | 5.0 | 5.0 | 5.0 |
| Accelerator (9) | 2.0 | 2.0 | — | — |
| CBS (10) | 0.9 | 0.9 | 0.9 | 0.9 |
| Properties | | | | |
| EB at 23° C. | 100 | 100 | NA* | NA* |
| BS at 23° C. | 100 | 110 | NA* | NA* |
| G* 5% at 60° C. | 100 | 145 | 100 | 152 |
| tan(δ)max at 60° C. | 100 | 113 | 100 | 83 |

(1) Natural rubber
(2) Elastomer E1 obtained according to the process described in point IV-2 above
(3) Carbon black of N115 grade according to standard ASTM D-1765
(4) Araldite ECN 1299 CH thermosetting epoxy resin from the company Huntsman
(5) Ethacure 300 amine-based hardener from the company Huntsman
(6) Santoflex 6-PPD N-(1,3-dimethylbutyl)-N-phenyl-para-phenylenediamine from the company Flexsys
(7) Pristerene 4931 stearic acid from the company Uniqema
(8) Industrial grade zinc oxide of from the company Umicore
(9) Aradur 3123ES imidazole-based accelerator from the company Huntsman
(10) Santocure CBS N-cyclohexy1-2-benzothiazolesulfenamide from the company Flexsys
*not available

The results shown in Table 4 above show that the combination of a copolymer according to the invention and a curing system based on an epoxy resin and an amine-based hardener according to the invention allows both the stiffness and the hysteresis of the composition to be improved without penalizing the mechanical properties, or even improving them. Comparison of the control compositions T2 and T3 shows that this effect is not related merely to the presence of the copolymer according to the invention. The compositions in accordance with the invention are particularly useful for applications requiring an excellent compromise between stiffness and hysteresis, such as in tyres, particularly in the internal layers of tyres.

1.-15. (canceled)

16. A rubber composition based on at least:
an elastomer matrix comprising more than 50 phr of at least one copolymer containing ethylene units and 1,3-diene units, the ethylene units in the copolymer representing between 50 mol % and 95 mol % of monomer units of the at least one copolymer;
a reinforcing filler;
a vulcanization system;
from 1 to 30 phr of epoxy resin;
between 1 and 15 phr of an amine-based hardener comprising at least two primary amine functions located on at least one six-membered aromatic ring, the at least one six-membered aromatic ring comprising:
at least one primary amine function, and
at least two radicals Ri, which may be identical or different, selected from the group consisting of linear or branched C₁-C₆ alkyl radicals, halogens, ethers, tertiary amines, thioethers, ketones, esters and amides, substituted with linear or branched C₁-C₆ alkyl radicals,
wherein the at least one six-membered aromatic ring does not comprise a hydrogen atom located in an ortho position relative to the primary amine functions, and
wherein the amine-based hardener comprises at least one second primary amine function located on the at least one six-membered aromatic ring or on a possible second six-membered aromatic ring of the amine-based hardener.

17. The rubber composition according to claim 16, wherein the at least one copolymer containing ethylene units and 1,3-diene units is a copolymer of ethylene and of a 1,3-diene.

18. The rubber composition according to claim 16, wherein a content of the at least one copolymer containing ethylene units and 1,3-diene units is within a range extending from 60 to 100 phr.

19. The rubber composition according to claim 16, wherein the epoxy resin is selected from the group consisting of aromatic epoxy, alicyclic epoxy, aliphatic epoxy resins, and mixtures thereof.

20. The rubber composition according to claim 16, wherein a content of the epoxy resin is between 5 and 25 phr.

21. The rubber composition according to claim 16, wherein the radicals Ri, which may be identical or different, are selected from the group consisting of linear or branched C₁-C₆ alkyl radicals, halogens, ethers, tertiary amines and thioethers, substituted with linear or branched C₁-C₆ alkyl radicals.

22. The rubber composition according to claim 16, wherein the at least one six-membered aromatic ring is an aromatic ring containing six carbon atoms.

23. The rubber composition according to claim 16, wherein the amine-based hardener corresponds to any one of formulae (III) to (V) and (VII): 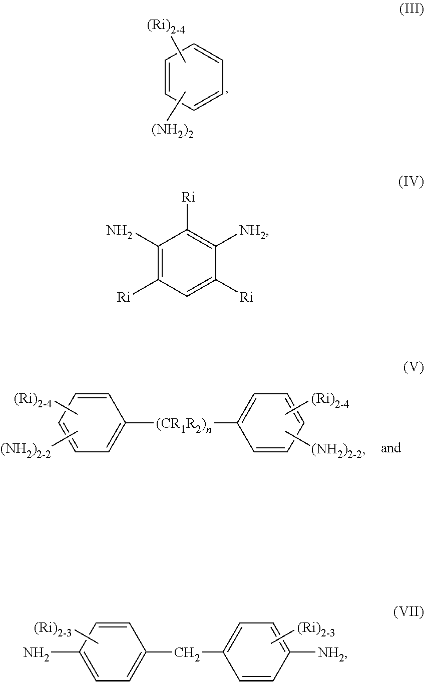
in which, in formula (V)
n represents an integer ranging from 0 to 4, and
R₁ and R₂, which may be identical or different, are selected from the group consisting of a hydrogen atom and a methyl, ethyl, isobutyl or benzyl group.

24. The rubber composition according to claim 16, wherein the amine-based hardener is selected from the group consisting of the compounds of formulae (VIII) to (XIII) below and mixtures thereof:

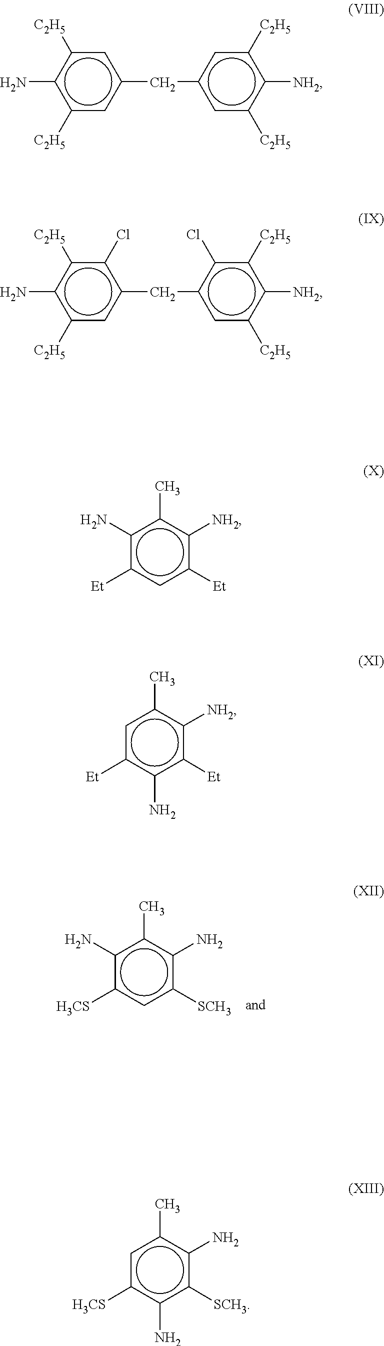

25. The rubber composition according to claim 16, wherein a content of amine-based hardener is within a range extending from 5 to 10 phr.

26. The rubber composition according to claim 16, further comprising an imidazole of formula (XIV): 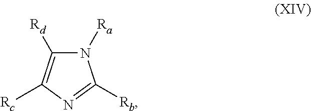
in which:
Ra represents a hydrogen atom or a hydrocarbon-based group which is optionally interrupted with one or more heteroatoms and/or substituted,
Rb represents a hydrocarbon-based group,
Rc and Rd represent, independently of each other, a hydrogen atom or a hydrocarbon-based group which is optionally interrupted with one or more heteroatoms and/or substituted,
or else Rc and Rd form, together with the carbon atoms of the imidazole ring to which they are attached, a ring which is optionally interrupted with one or more heteroatoms and/or substituted.

27. The rubber composition according to claim 26, wherein a content of imidazole of formula (XIV) is within a range extending from 0.1 to 5 phr.

28. The rubber composition according to claim 16, wherein the reinforcing filler comprises more than 50% by weight of carbon black.

29. The rubber composition according to claim 16, wherein a content of the reinforcing filler is within a range extending from 10 to less than 100 phr.

30. A tire comprising the rubber composition according to claim 16.

31. The tire according to claim 30, wherein the rubber composition is present in at least one internal layer selected from the group consisting of carcass plies, crown plies, bead fillers, crown butts, decoupling layers, edge rubbers, filling rubbers, a tread underlayer and combinations thereof.
